(19) United States
(12) Patent Application Publication
(10) Pub. No.: US 2026/0334496 A1
(43) Pub. Date: Oct. 29, 2026

(54) FOOD COATING AGENT, FOOD PRODUCT, AND METHOD FOR MANUFACTURING FOOD PRODUCT

(71) Applicant: THE NISSHIN OILLIO GROUP, LTD., Chuo-ku, Tokyo (JP)

(72) Inventors: Taichi WATANABE, Yokohama-shi, Kanagawa (JP); Takahiro OKADA, Yokohama-shi, Kanagawa (JP)

(73) Assignee: THE NISSHIN OILLIO GROUP, LTD., Chuo-ku, Tokyo (JP)

(21) Appl. No.: 19/122,165

(22) PCT Filed: Oct. 18, 2023
(86) PCT No.: PCT/JP2023/037770

§ 371 Date: Apr. 17, 2025

(30) Foreign Application Priority Data
Oct. 21, 2022 (JP) 2022-168972

(51) Int. Cl. A23C 19/16

(52) U.S. Cl. CPC A23C 19/16

(57) ABSTRACT

A food coating agent that reduces hardening of an exposed surface cheese portion of a food product being cheese or including exposed cheese, a food product being cheese or including exposed cheese with reduced hardening of an exposed surface cheese portion of the food product over time, and a method for manufacturing the food product are provided. The food coating agent for a food product being cheese or including exposed cheese includes 50 to 99.9% by mass of an oil and/or fat, and 0.1 to 50% by mass of an emulsifier with an HLB value of 1 to 8. The emulsifier may include at least one or at least two selected from the group consisting of a propylene glycol ester of a fatty acid, a polyglycerol ester of a fatty acid, a polyglycerol ester of interesterified ricinoleic acid, an organic acid monoglyceride, a sucrose fatty acid ester, and a sorbitan fatty acid ester.

### TECHNICAL FIELD

The present invention relates to a food coating agent, a food product, and a method for manufacturing a food product.

### BACKGROUND ART

To reduce cooking effort in restaurants and households, an increasing number of prepared foods are being distributed, stored, and served as meals either directly or after being heated in a microwave oven. However, such food products can have flavor or texture or both flavor and texture deteriorating over time during distribution and storage. For example, food products containing cheese, such as pizza, pizza toast, and cheeseburgers, may undergo hardening of exposed cheese surfaces over time. During storage, such food products can have poor texture and deteriorating cheese flavor to spread in the mouth. For food products containing cheese, the best-before date (the date by which food can be eaten deliciously) may be determined mainly based on the texture and flavor of the cheese. Preventing the hardening of cheese allows such food products containing cheese to have an extended best-before date, thus possibly reducing food loss.

Patent Document 1 describes a technique for coating cheese placed on processed food products such as pizza with an oil and/or fat to prevent incomplete melting of the cheese.

### CITATION LIST

### Patent Document

Patent Document 1: Japanese Unexamined Patent Application Publication No. 2017-86035

### SUMMARY OF INVENTION

### Technical Problem

However, the technique in Patent Document 1 cannot sufficiently reduce hardening of cheese. One or more aspects of the present invention are thus directed to a food coating agent that reduces hardening of an exposed surface cheese portion of a food product being cheese or a food product including exposed cheese over time, a food product being cheese or including exposed cheese with reduced hardening of an exposed surface cheese portion of the food product, and a method for manufacturing the food product.

### Solution to Problem

The inventors have conducted extensive studies and found that a food coating agent containing 50 to 99.9% by mass of an oil and/or fat and 0.1 to 50% by mass of an emulsifier with a hydrophilic-lipophilic balance (HLB) value of 1 to 8 applied to an exposed cheese surface reduces hardening of the cheese surface portion, and have completed the present invention.

More specifically, the present invention provides aspects (1) to (10) below.
(1) A food coating agent for a food product being cheese or including exposed cheese, the food coating agent comprising:
50 to 99.9% by mass of an oil and/or fat; and
0.1 to 50% by mass of an emulsifier with a hydrophilic-lipophilic balance value of 1 to 8.
(2) The food coating agent according to (1), wherein the emulsifier includes at least one or at least two selected from the group consisting of a propylene glycol ester of a fatty acid, a polyglycerol ester of a fatty acid, a polyglycerol ester of interesterified ricinoleic acid, an organic acid monoglyceride, a sucrose fatty acid ester, and a sorbitan fatty acid ester.
(3) The food coating agent according to (1) or (2), wherein
at least 0.002 g/cm² of the food coating agent is to be applied to a partial area or an entire area of an exposed cheese surface of the food product for reduced hardening of a surface cheese portion of the food product.
(4) The food coating agent according to (1) or (2), wherein
the food coating agent is to be applied before or after the food product being cheese or including exposed cheese is heated.
(5) A food product being cheese or including exposed cheese, the food product comprising:
an exposed cheese surface; and
at least 0.002 g/cm² of a food coating agent applied on the exposed cheese surface, the food coating agent containing 50 to 99.9% by mass of an oil and/or fat and 0.1 to 50% by mass of an emulsifier with a hydrophilic-lipophilic balance value of 1 to 8.
(6) The food product according to (5), wherein
the emulsifier includes at least one or at least two selected from the group consisting of a propylene glycol ester of a fatty acid, a polyglycerol ester of a fatty acid, a polyglycerol ester of interesterified ricinoleic acid, an organic acid monoglyceride, a sucrose fatty acid ester, and a sorbitan fatty acid ester.
(7) The food product according to (5) or (6), wherein
the food product is a heated food product.
(8) A method for manufacturing a food product being cheese or including exposed cheese, the method comprising:
applying at least 0.002 g/cm² of a food coating agent to an exposed cheese surface of the food product, the food coating agent containing 50 to 99.9% by mass of an oil and/or fat and 0.1 to 50% by mass of an emulsifier with a hydrophilic-lipophilic balance value of 1 to 8.
(9) The method according to (8), wherein
the emulsifier includes at least one or at least two selected from the group consisting of a propylene glycol ester of a fatty acid, a polyglycerol ester of a fatty acid, a polyglycerol ester of interesterified ricinoleic acid, an organic acid monoglyceride, a sucrose fatty acid ester, and a sorbitan fatty acid ester.
(10) The method according to (8) or (9), wherein
the applying the food coating agent includes applying the food coating agent to a heated food product, or the method further comprises heating the food product before or after the applying the food coating agent.

### Advantageous Effects of Invention

The technique according to the above aspects of the present invention reduces hardening of an exposed surface cheese portion of a food product being cheese or including exposed cheese. The food product being cheese or including exposed cheese with reduced hardening can maintain intended texture of the surface cheese portion and thus can have a later best-before date by which the food product can be eaten deliciously.

### DESCRIPTION OF EMBODIMENTS

One or more embodiments of the present invention will now be described in detail by way of example. In the embodiments of the present invention, a range expressed as A (numerical value) to B (numerical value) refers to a range of not less than A and not more than B. Implementations illustrated below using specific terms such as preferable, preferably, more preferable, more preferably, or any similar terms may be combined in any manner independently of such specific terms. The numerical ranges are mere examples. The upper limit and the lower limit of each range and numerical values in the illustrated examples may be combined as appropriate. Further, the terms such as containing, including, or equivalents are replaceable by “consisting essentially of” and “consisting of.”

### Food Coating Agent

A food coating agent according to one or more embodiments of the present invention is a food coating agent for a food product being cheese or including exposed cheese for reduced hardening of a cheese surface portion of the food product. The food coating agent contains 50 to 99.9% by mass of an oil and/or fat, and 0.1 to 50% by mass of an emulsifier with an HLB value of 1 to 8.

### Cheese

The food coating agent according to one or more embodiments of the present invention is a food coating agent for a food product being cheese or including exposed cheese. Examples of such cheese include natural cheese and processed cheese that are either manufactured or are being sold.

Examples of such natural cheese include cheese made of the milk of animals such as cows, sheep, and goats. Lactic acid bacteria and milk coagulating enzymes (rennet) are added to the milk to coagulate the milk components (protein) to produce coagulated milk, from which whey is partially removed. The coagulated milk is then fermented and ripened using microorganisms including lactic acid bacteria and mold. Other examples include natural cheese with an additional flavoring component to enhance aroma and flavor. Examples of natural cheese include fresh cheese, white mold-rind cheese, washed-rind cheese, chevre (goat milk cheese), blue cheese, semi-hard cheese, hard cheese, and extra-hard cheese.

Examples of processed cheese include cheese produced by adding an emulsifier to natural cheese, followed by heating, melting, and emulsifying, and then forming and cooling. Such processed cheese may additionally contain cream, butter, and butter oil to adjust the fat content, may contain an additional flavoring component to enhance aroma and flavor, or may contain both. Such processed cheese may contain other food products to add aroma, flavor, nutrients, functionality, and properties. In this case, the content of such other food products to be added is preferably within one sixth of the solid weight of the cheese (the content of milk ingredients other than cream, butter, and butter oil to be added is preferably within the range in which the lactose content in the cheese does not exceed 5%).

The food coating agent according to one or more embodiments of the present invention may be used preferably for natural cheese defined in Article 2, Paragraph 17 of the Ministerial Ordinance on Milk and Milk Products Concerning Compositional Standards, etc. (Ordinance of the Ministry of Health and Welfare No. 52 of 1951) based on the Food Sanitation Act (Act No. 233 of 1947), and for processed cheese defined in Article 2, Paragraph 18 of the Ministerial Ordinance on Milk and Milk Products Concerning Compositional Standards, etc. satisfying the specifications of the components specified in Item 4 in Section (3) of attached Table 2 in the Ministerial Ordinance.

Exposed surface cheese portions can harden when the moisture content on the cheese surface decreases or the surface oxidizes. The food coating agent according to one or more embodiments of the present invention may be applied to an exposed surface cheese portion in a food product being cheese or including exposed cheese for reduced hardening of the exposed surface cheese portion to reduce moisture content decrease or surface oxidation. The exposed cheese surface may be coated with at least 0.002 g/cm² of the food coating agent to produce sufficient effects. The exposed cheese surface may be coated preferably with 0.003 to 0.1 g/cm² of the food coating agent, more preferably with 0.01 to 0.1 g/cm² of the food coating agent, still more preferably with 0.03 to 0.08 g/cm² of the food coating agent, and most preferably with 0.04 to 0.06 g/cm² of the food coating agent.

Cheese prepared by heating contains less moisture immediately after being heated and has surface portions more susceptible to hardening over time. To be more effective, the food coating agent according to one or more embodiments of the present invention may be preferably applied before such cheese is exposed to air for a prolonged period of time. In cooking including heating cheese, for example, the food coating agent may be more preferably applied before the food product being cheese or including exposed cheese is heated, during heating, or within 30 minutes after the heating.

Oil and/or Fat

The food coating agent according to one or more embodiments of the present invention contains 50 to 99.9% by mass of an oil and/or fat to reduce hardening of the surface cheese portion in combination with an emulsifier (described later). Examples of such an oil and/or fat include animal and vegetable oils and/or fats, oils and/or fats synthesized from glycerol and a fatty acid and their fractionated oils, esterified oils, and hydrogenated oils that are used solely or in combination.

Examples of such an animal or vegetable oil and/or fat include soybean oil, rapeseed oil, sunflower oil, olive oil, safflower oil, corn oil, cottonseed oil, rice bran oil, sesame oil, perilla oil, linseed oil, peanut oil, grape seed oil, beef fat, butterfat, fish oil, coconut oil, palm oil, and palm kernel oil.

Examples of such an oil and/or fat synthesized from glycerol and a fatty acid include oils and/or fats containing a straight-chain saturated fatty acid with 8 to 10 carbon atoms, such as a medium-chain triglyceride (MCT).

Examples of such a fractionated oil include fractionated palm oils such as palm olein, super palm olein, palm stearin, and palm mid fraction.

Examples of such an esterified oil include esterified oils resulting from ester-exchange of palm oil or fractionated palm oil and another liquid oil and/or fat, or esterified oils of MCT and vegetable oils or other oils.

Examples of such a hydrogenated oil include hydrogenated oils of animal or vegetable oils and/or fats or fractionated animal or vegetable oils and/or fats and hydrogenated oils of esterified oils.

An oil and/or fat that loses fluidity at room temperature is to be melted by heating when applied to the surface of a food product. Thus, an oil and/or fat used in one or more embodiments of the present invention may preferably be an oil and/or fat that is fluid at 30 °C. Even if a portion of raw oils and/or fats is solid at 30 °C, it may still be used suitably in combination with other raw oil and/or fat, as long as the overall oil and/or fat remains fluid. An oil and/or fat used in one or more embodiments of the present invention may preferably be an oil and/or fat that is fluid at 20 °C, or more preferably be an oil and/or fat that is liquid at 20 °C. In particular, liquid oils with a low melting point and high stability to oxidation may preferably be used, including rapeseed oil, soybean oil, corn oil, palm olein, and an oil and/or fat containing straight-chain saturated fatty acid with 8 to 10 carbon atoms as its constituent fatty acid, or a mixture of two or more of these.

The food coating agent according to one or more embodiments of the present invention may preferably contain 70 to 99.7% by mass of an oil and/or fat. The food coating agent may more preferably contain 80 to 99.5% by mass of such an oil and/or fat, still more preferably 85 to 98.5% by mass of the oil and/or fat, or most preferably 92 to 98% by mass of the oil and/or fat.

### Emulsifier

The food coating agent according to one or more embodiments of the present invention contains 0.1 to 50% by mass of an emulsifier with an HLB value of 1 to 8 to reduce hardening of the surface cheese portion. Examples of such an emulsifier with an HLB value of 1 to 8 may be at least one or at least two selected from the group consisting of a propylene glycol ester of a fatty acid, a polyglycerol ester of a fatty acid, a polyglycerol ester of interesterified ricinoleic acid, an organic acid monoglyceride, a sucrose fatty acid ester, and a sorbitan fatty acid ester.

The emulsifier may preferably have an HLB value of 3 to 8, and more preferably have an HLB value of 6 to 8.

The HLB, or the hydrophilic-lipophilic balance, indicates whether the emulsifier is hydrophilic or lipophilic and can have a value of 0 to 20. A lower HLB value indicates a stronger lipophilicity. In one or more embodiments of the present invention, the HLB value is calculated using the Atlas HLB system. The HLB value is calculated with the Atlas HLB system as

HLB=20×(1−S/A),
where S is the saponification value, and A is the neutralization value of a fatty acid in an ester.

With this calculation system, the HLB value is calculated as an arithmetic mean.

The emulsifier used in the food coating agent according to one or more embodiments of the present invention may preferably contain an unsaturated fatty acid that constitutes at least 60% by mass of the constituent fatty acids to prevent solidification at low temperature. The emulsifier may more preferably contain an unsaturated fatty acid that constitutes 70 to 100% by mass of the constituent fatty acids, and still more preferably contain an unsaturated fatty acid that constitutes 80 to 98% by mass of the constituent fatty acids. The unsaturated fatty acid may be a straight-chain unsaturated fatty acid with 16 to 22 carbon atoms. The unsaturated fatty acid may preferably be at least one or at least two selected from the group consisting of oleic acid, linoleic acid, linolenic acid, and erucic acid. The unsaturated fatty acid may more preferably be oleic acid that constitutes 65 to 90% by mass of the constituent fatty acids. The emulsifier contains a saturated fatty acid as a fatty acid other than an unsaturated fatty acid. The saturated fatty acid may preferably be a straight-chain saturated fatty acid with 6 to 22 carbon atoms, and may more preferably be a straight-chain saturated fatty acid with 16 to 22 carbon atoms, and may still more preferably be at least one or at least two selected from the group consisting of palmitic acid, stearic acid, and behenic acid.

The food coating agent according to one or more embodiments of the present invention may preferably contain 0.3 to 30% by mass of an emulsifier with an HLB value of 1 to 8. The food coating agent may more preferably contain 0.5 to 20% by mass of such an emulsifier with an HLB value of 1 to 8, still more preferably contain 1.5 to 15% by mass of the emulsifier, and most preferably 2 to 8% by mass of the emulsifier.

The propylene glycol ester of the fatty acid may be an ester of propylene glycol and a fatty acid and may be a commercially available product or may be manufactured with a known method. Examples of such a commercially available product include Type BP (HLB=4.2), RIKEMAL PP-100 (HLB=3.8), and RIKEMAL PO-100V (HLB=3.6) (Riken Vitamin Co., Ltd.), and may be used as appropriate. The propylene glycol ester of the fatty acid may preferably be a propylene glycol ester of a fatty acid with an HLB value of 3 to 8, and may more preferably be a propylene glycol ester of a fatty acid with an HLB value of 3 to 5.

The polyglycerol ester of the fatty acid is an ester of polyglycerol and a fatty acid and may be a commercially available product or may be manufactured with a known method. Examples of such a commercially available product include SUNSOFT Q-17B (HLB=6.5), SUNSOFT Q-175S (HLB=4.5), SUNSOFT Q1710S (HLB=3.0), and SUNSOFT A-173E (HLB=7.0) (Taiyo Kagaku Co., Ltd.) and POEM DO-100V (HLB=7.3) (Riken Vitamin Co., Ltd.), and may be used as appropriate.

Polyglycerol used as a raw material of the polyglycerol ester of a fatty acid is typically prepared by dehydration and condensation of glycerol at high temperature in the presence of an alkali catalyst such as caustic soda, followed by distillation, deodorization, and decolorization as appropriate. Polyglycerol as a raw material of such a polyglycerol ester of a fatty acid is also referred to as reaction polyglycerol, which is a polyglycerol mixture with different degrees of polymerization and with a wide distribution of polymerization degrees. A polyglycerol ester of a fatty acid with a polymerization degree of 4 or higher is typically difficult to isolate and may be a mixture of polyglycerol esters of fatty acids with different degrees of polymerization. Examples of a polyglycerol ester of a fatty acid in one or more embodiments of the present invention include polyglycerol esters of fatty acids containing polyglycerol with an average polymerization degree of 2 to 40 and more preferably containing polyglycerol with an average polymerization degree of 2 to 12. The average polymerization degree indicates the polymerization degree of polyglycerol contained in a polyglycerol ester of a fatty acid. The average polymerization degree herein is a value calculated based on the hydroxyl value of polyglycerol as a raw material of a polyglycerol ester of a fatty acid. For example, the average polymerization degree (n) can be derived using Formulas 1 and 2 below.

Molecular weight=74n+18 (1)

Hydroxyl value=56110(n+2)/molecular weight (2)

Polyglycerol is typically sold as, for example, tetraglycerol (average polymerization degree of 4), hexaglycerol (average polymerization degree of 6), or decaglycerol (average polymerization degree of 10) depending on the average polymerization degree determined through end group analysis using the measured hydroxyl value. Thus, the average polymerization degree is a calculated value and may differ from the actual degree of polymerization.

The polyglycerol ester of interesterified ricinoleic acid may be a commercially available product or may be manufactured with a known method. Examples of such a commercially available product include SY-Glyster CR-310, SY-Glyster CR-500, SY-Glyster CR-ED, and SY-Glyster CRS-75 (Sakamoto Yakuhin Kogyo Co., Ltd.), SUNSOFT No. 818DG, SUNSOFT 818R, SUNSOFT 818SK, and SUNSOFT 818H (Taiyo Kagaku Co., Ltd.), and POEM PR-300 and POEM PR-400 (Riken Vitamin Co., Ltd.), and may be used as appropriate.

An organic acid monoglyceride is an ester of a fatty acid monoglyceride and an organic acid and may be a commercially available product or may be manufactured with a known method. Examples of such an organic acid for the organic acid monoglyceride include, but are not limited to, citric acid, succinic acid, acetic acid, tartaric acid, and butyric acid. The organic acid may preferably be citric acid that can effectively prevent burning of the product in a microwave oven. Examples of such a commercially available product include SUNSOFT No. 621B, SUNSOFT No. 623M, SUNSOFT No. 681NU, and SUNSOFT No. 641D (Taiyo Kagaku Co., Ltd.), and may be used as appropriate.

A sucrose fatty acid ester is an ester of sucrose and a fatty acid and may be a commercially available product or may be manufactured with a known method. Examples of such a commercially available product include RYOTO SUGAR ESTER O-170 (HLB=1), RYOTO SUGAR ESTER P-170 (HLB=1), RYOTO SUGAR ESTER S-170 (HLB=1), RYOTO SUGAR ESTER S-270 (HLB=2), RYOTO SUGAR ESTER S-370 (HLB=3), RYOTO SUGAR ESTER B-370 (HLB=3), RYOTO SUGAR ESTER ER-290 (HLB=2), and RYOTO SUGAR ESTER POS-135 (HLB=1) (Mitsubishi Chemical Corporation), and may be used as appropriate.

A sorbitan fatty acid ester is an ester of sorbitan and a fatty acid and may be a commercially available product or may be manufactured with a known method. Examples of such a commercially available product include RIKEMAL L250A (HLB=7.4), RIKEMAL OV-250 (HLB=4.9), RIKEMAL OR-85 (HLB=3.0), and POEM O-80V (HLB=4.9) (Riken Vitamin Co., Ltd.), and may be used as appropriate.

The emulsifier contained in the food coating agent may preferably be at least one or at least two selected from the group consisting of a propylene glycol ester of a fatty acid with an HLB value of 3 to 8 and a polyglycerol ester of a fatty acid with an HLB value of 2 to 8.

### Other Components

The food coating agent according to one or more embodiments of the present invention may include components commonly contained in a edible oil and/or fat, in addition to the above components. More specifically, examples of such components include a flavor enhancer, a colorant, an aromatic, an antioxidant, a stabilizer, and an emulsifier other than the emulsifier described above. The contents of such components may be determined as appropriate when these components do not degrade the effects produced by the embodiments of the present invention. For example, the food coating agent may contain not more than 10% by mass of such components, preferably not more than 3% by mass, more preferably 0 to 3% by mass, and still more preferably 0 to 1% by mass. The food coating agent may contain water soluble components in a soluble state.

Food Product (Food Product being Cheese or Including Exposed Cheese)

The food product according to one or more embodiments of the present invention is a food product being cheese or including exposed cheese. The food product has at least 0.002 g/cm² of the food coating agent described above applied on the exposed cheese surface.

The food coating agent contains 50 to 99.9% by mass of an oil and/or fat and 0.1 to 50% by mass of an emulsifier with an HLB value of 1 to 8. Examples of cheese described above in Cheese in Food coating agent may be used. The details of the food coating agent, the coating amount, and other information are provided in Food coating agent described above.

Examples of such a food product including exposed cheese according to one or more embodiments of the present invention include pizza, gratin, lasagna, cheese on toast, a cheeseburger, and a cheese sandwich.

As described above, cheese prepared by heating produces more advantageous effects of the embodiments of the present invention. Thus, the food product may preferably be a heated food product. The food product may more preferably be a baked food product such as pizza, gratin, lasagna, baked cheese, and a baked cheese sandwich.

### Method for Manufacturing Food Product

A method for manufacturing a food product according to one aspect of the present invention is a method for manufacturing a food product being cheese or including exposed cheese.

The method includes applying at least 0.002 g/cm² of a food coating agent to an exposed cheese surface of the food product. The food coating agent contains 50 to 99.9% by mass of an oil and/or fat and 0.1 to 50% by mass of an emulsifier with an HLB value of 1 to 8. Examples of cheese described above in Cheese in Food coating agent may be used. Examples of food products are provided in Food Product (Food Product Being Cheese or Including Exposed Cheese) described above.

Applying at least 0.002 g/cm² of the food coating agent to an exposed cheese surface includes applying the food coating agent to a cheese surface or to a cheese surface of a food product including exposed cheese. For example, the food coating agent may be sprayed onto a food product (cheese), the food coating agent may be applied to a food product (cheese), a food product (cheese) may be immersed in the food coating agent, or a food product (cheese) and the food coating agent may be mixed. Through this process, the cheese surface is coated with the food coating agent to reduce hardening of the surface cheese portion in one or more embodiments of the present invention. The details of the food coating agent, the coating amount, and other information are provided in Food coating agent described above.

As described above, cheese prepared by heating produces more advantageous effects of the embodiments of the present invention. Thus, the method according to one or more embodiments of the present invention may preferably be the method including applying the food coating agent to a heated food product, or the method further including heating the food product before, at the same time as, or after applying the food coating agent. As described above, the food coating agent is to be more preferably applied before the food product being cheese or including exposed cheese is heated, during heating, or within 30 minutes after the heating. Thus, the method according to one or more embodiments of the present invention may more preferably be the method including applying the food coating agent to a heated food product that has been heated within 30 minutes before the food coating agent is applied, or the method further including heating the food product within 30 minutes before, at the same time as, or after applying the food coating agent.

### EXAMPLES

Although examples and comparative examples will now be described in more detail, the present invention is not limited to these examples. Hereafter, the percent (%) refers to the percent by mass unless otherwise specified.

### Food Coating Agent

Food coating agents with compositions in Tables 1 to 5 were prepared. Food coating agents in Comparative Examples 2 and 3 and Examples 1 to 17 were prepared by heating and mixing an emulsifier and an oil and/or fat (at 40 to 60 °C). The same food coating agent as in Example 4 was used in each of Examples 18 to 23 in Tables 6 and 7. In Reference Examples 1 and 2, no food coating agent was applied. The following oil and/or fat and emulsifiers were used.

Oil and/or Fat

Rapeseed oil (refined canola oil under the product name Nisshin Canola Oil; the Nisshin OilliO Group, Ltd.)

### Emulsifier

PGPR1 (pentaglycerol ester of interesterified ricinoleic acid under the product name SUNSOFT No. 818R with an HLB value of 3 or lower; Taiyo Kagaku Co., Ltd.)
PGPR2 (hexaglycerol ester of interesterified ricinoleic acid under the product name SY-Glyster CR-500 with an HLB value of 3 or lower; Sakamoto Yakuhin Kogyo Co., Ltd.)
PE (propylene glycol oleate under the product name RIKEMAL PO-100V with an HLB value of 3.6; Riken Vitamin Co., Ltd.)
PGE1 (diglycerol monooleate under the product name POEM DO-100V with an HLB value of 7.3; Riken Vitamin Co., Ltd.)
PGE2 (decaglycerol decaoleate under the product name SUNSOFT Q-1710S with an HLB value of 3; Taiyo Kagaku Co., Ltd.)
PGE3 (decaglycerol pentaoleate under the product name SUNSOFT Q-175S with an HLB value of 7; Taiyo Kagaku Co., Ltd.)
Organic acid monoglyceride (MG) (citric acid monooleate glycerol under the product name SUNSOFT No. 623M with an HLB value of 7; Taiyo Kagaku Co., Ltd.)
SOE (sorbitan oleate under the product name POEM O-80V with an HLB value of 4.9; Riken Vitamin Co., Ltd.)
SUE 1 (sucrose stearate under the product name RYOTO SUGAR ESTER S-170 with an HLB value of 1; Mitsubishi Chemical Corporation)
SUE 2 (sucrose oleate under the product name RYOTO SUGAR ESTER O-170 with an HLB value of 1; Mitsubishi Chemical Corporation)
SUE 3 (sucrose palmitate under the product name RYOTO SUGAR ESTER P-170 with an HLB value of 1; Mitsubishi Chemical Corporation)
SUE 4 (sucrose palmitate under the product name RYOTO SUGAR ESTER S-1670 with an HLB value of 16; Mitsubishi Chemical Corporation)

### Cheese Application Test 1

Commercially available sliced cheese, TOPVALU Sliced Cheese (Marinfood Co., Ltd.), was cut into 4 cm squares and placed on a plate. Subsequently, 0.5 g (0.031 g/cm²) of each of the food coating agents was applied to the top surfaces of the cut cheese pieces (surfaces exposed to air). The rupture strength was measured after three hours of storage exposed to air (25 °C). The rupture strength was measured with a rheometer (Texture Analyzer with the model name TA.XA-Plus; Stable Micro Systems) under measurement conditions: the drop velocity of 1 mm/sec, the tool being a Blade Set, and the strain setting to stop at 98%. Tables 1 to 5 show the measured rupture strength (the maximum strength measured with ruptures of up to 98%). For Reference Example 1, Comparative Example 1, and Example 1, the rupture strength was also measured immediately after the food coating agent was applied (before storage).

As the cheese surface hardens, the rupture strength increases. For Reference Example 1, Comparative Example 1, and Example 1, the rupture strength is about 250 g/cm² immediately after the food coating agent was applied (before storage) and increases as the cheese surface hardens more. Thus, a lower rupture strength measured after three hours indicates less hardening of the cheese surface. The rupture strength after three hours (3-hour rupture strength) was evaluated with the criteria below. Tables 1 to 5 show the results.
Rupture strength of 450 g or greater: x (Fail)
Rupture strength of 400 to 449 g: Δ (Fail)
Rupture strength of 350 to 399 g: ● (Pass)
Rupture strength of 300 to 349 g: O (Pass: Good)
Rupture strength of 299 g or less: ⊚ (Pass: Excellent)

TABLE 1

| | Reference | Comparative | |
|---|---|---|---|
| | Example 1 | Example 1 | Example 1 |
| Rapeseed oil | — | 100 | 99 |
| (mass %) | | | |
| PGPR1 (mass %) | — | — | 1 |
| Rupture strength (g) | 454.7 (248.8) | 442.5 (242.1) | 315.9 (238.5) |
| After 3 h of storage | X | Δ | ◯ |
| (before storage) | | | |

TABLE 2

| | Comparative | | | |
|---|---|---|---|---|
| | Example 2 | Example 2 | Example 3 | Example 4 |
| Rapeseed oil | 99.05 | 99.9 | 99.5 | 99 |
| (mass %) | | | | |
| PGE1 (mass %) | 0.05 | 0.1 | 0.5 | 1 |
| Rupture strength (g) | 430.8 | 391.5 | 288.9 | 264.3 |
| After 3 h of storage | Δ | ● | ⊚ | ⊚ |

TABLE 3

| | Example 5 | Example 6 | Example 7 | Example 8 |
|---|---|---|---|---|
| Rapeseed oil | 98 | 95 | 90 | 80 |
| (mass %) | | | | |
| PGE1 (mass %) | 2 | 5 | 10 | 20 |
| Rupture strength (g) | 257.1 | 240.3 | 248.1 | 260.9 |
| After 3 h of storage | ⊚ | ⊚ | ⊚ | ⊚ |

TABLE 4

| | Example | Example | Example | Example | Example |
|---|---|---|---|---|---|
| | 9 | 10 | 11 | 12 | 13 |
| Rapeseed oil | 99 | 99 | 99 | 99 | 99 |
| (mass %) | | | | | |
| PGPR2 | 1 | — | — | — | — |
| (mass %) | | | | | |
| PE (mass | — | 1 | — | — | — |
| %) | | | | | |
| PGE2 | — | — | 1 | — | — |
| (mass %) | | | | | |
| PGE 3 | — | — | — | 1 | — |
| (mass %) | | | | | |
| Organic acid | — | — | — | — | 1 |
| MG (mass | | | | | |
| %) | | | | | |
| Rupture | 301.4 | 277.7 | 298.5 | 250.6 | 254.1 |
| strength (g) | ◯ | ⊚ | ⊚ | ⊚ | ⊚ |
| After 3 h | | | | | |
| of storage | | | | | |

TABLE 5

| | Example | Example | Example | Example | Comparative |
|---|---|---|---|---|---|
| | 14 | 15 | 16 | 17 | Example 3 |
| Rapeseed oil | 99 | 99 | 99 | 99 | 99 |
| (mass %) | | | | | |
| SOE (mass %) | 1 | — | — | — | — |
| SUE1 (mass %) | — | 1 | — | — | — |
| SUE2 (mass %) | — | — | 1 | — | — |
| SUE3 (mass %) | — | — | — | 1 | — |
| SUE4 (mass %) | — | — | — | — | 1 |
| Rupture strength (g) | 375.9 | 314.1 | 321.7 | 332.1 | 433.2 |
| After 3 h of storage | ● | ◯ | ◯ | ◯ | Δ |

In each of Examples 1 to 17, the rupture strength measured after the cheese was stored for three hours is lower than in Reference Example 1 and Comparative Examples 1 to 3, indicating that the hardening of the cheese (surface portion) over time was reduced.

### Cheese Application Test 2

Commercially available sliced cheese, TOPVALU Sliced Cheese (Marinfood Co., Ltd.), was cut into 4 cm squares and placed on a plate. Subsequently, 0.05 to 1.0 g (0.003 to 0.063 g/cm²) of each of the food coating agents in Table 6 was applied to the top surfaces of the cut cheese pieces (surfaces exposed to air). The rupture strength was measured after three hours of storage exposed to air (25 °C). The rupture strength was measured and evaluated in the same manner as in Cheese Application Test 1. Table 6 shows the results.

TABLE 6

| | Exam- | Exam- | Exam- | Exam- | Exam- |
|---|---|---|---|---|---|
| | ple 18 | ple 19 | ple 20 | ple 21 | ple 22 |
| Rapeseed oil | 99 | 99 | 99 | 99 | 99 |
| (mass %) | | | | | |
| PGE1 (mass %) | 1 | 1 | 1 | 1 | 1 |
| Surface | 0.05 | 0.2 | 0.3 | 0.7 | 1.0 |
| application | (0.003) | (0.013) | (0.019) | (0.044) | (0.063) |
| amount (g) | | | | | |
| (g/cm²) | | | | | |
| Rupture | 332.1 | 251.3 | 260.7 | 245.6 | 252.2 |
| strength (g) | ◯ | ⊚ | ⊚ | ⊚ | ⊚ |
| After 3 h | | | | | |
| of storage | | | | | |

In each of Examples 18 to 22, the rupture strength measured after the cheese was stored for three hours is lower than in Reference Example 1 and Comparative Examples 1 to 3, indicating that the hardening of the cheese (surface portion) over time was reduced.

### Cheese Application Test 3

Commercially available sliced cheese, TOPVALU Sliced Cheese (Marinfood Co., Ltd.), was cut into 4 cm squares and placed on a plate, and heated in a microwave oven (500 W for ten seconds). Subsequently, 0.5 g (0.031 g/cm²) of each of the food coating agents was applied to the top surfaces of the cut cheese pieces (surfaces exposed to air). The rupture strength was measured after three hours of storage exposed to air (25 °C). The rupture strength was measured in the same manner as in Cheese Application Test 1. Table 7 shows the results.

TABLE 7

| | Reference | Comparative | |
|---|---|---|---|
| | Example 2 | Example 4 | Example 23 |
| Rapeseed oil (mass %) | — | 100 | 99 |
| PGE1 (mass %) | — | — | 1 |
| Rupture strength (g) | 1129.6 | 1157.3 | 713.7 |
| After 3 h of storage | | | |

The results in Table 7 show that the rupture strength was higher than in Reference Example 1, Comparative Example 1, and Example 4, yet seemingly due to the moisture content of the cheese decreased by heating. However, the rupture strength was markedly lower in Example 23 using the food coating agent according to one or more embodiments of the present invention than in Reference Example 2 and Comparative Example 4, indicating that the hardening of the cheese (surface portion) over time was reduced.

1. A food coating agent for a food product being cheese or including exposed cheese, the food coating agent comprising:
50 to 99.9% by mass of an oil and/or fat; and
0.1 to 50% by mass of an emulsifier with a hydrophilic-lipophilic balance value of 1 to 8.

2. The food coating agent according to claim 1, wherein
the emulsifier includes at least one or at least two selected from the group consisting of a propylene glycol ester of a fatty acid, a polyglycerol ester of a fatty acid, a polyglycerol ester of interesterified ricinoleic acid, an organic acid monoglyceride, a sucrose fatty acid ester, and a sorbitan fatty acid ester.

3. The food coating agent according to claim 1, wherein
at least 0.002 g/cm² of the food coating agent is to be applied to a partial area or an entire area of an exposed cheese surface of the food product for reduced hardening of a surface cheese portion of the food product.

4. The food coating agent according to claim 1, wherein
the food coating agent is to be applied before or after the food product being cheese or including exposed cheese is heated.

5. A food product being cheese or including exposed cheese, the food product comprising:
an exposed cheese surface; and
at least 0.002 g/cm² of a food coating agent applied on the exposed cheese surface, the food coating agent containing 50 to 99.9% by mass of an oil and/or fat and 0.1 to 50% by mass of an emulsifier with a hydrophilic-lipophilic balance value of 1 to 8.

6. The food product according to claim 5, wherein
the emulsifier includes at least one or at least two selected from the group consisting of a propylene glycol ester of a fatty acid, a polyglycerol ester of a fatty acid, a polyglycerol ester of interesterified ricinoleic acid, an organic acid monoglyceride, a sucrose fatty acid ester, and a sorbitan fatty acid ester.

7. The food product according to claim 5, wherein
the food product is a heated food product.

8. A method for manufacturing a food product being cheese or including exposed cheese, the method comprising:
applying at least 0.002 g/cm² of a food coating agent to an exposed cheese surface of the food product, the food coating agent containing 50 to 99.9% by mass of an oil and/or fat and 0.1 to 50% by mass of an emulsifier with a hydrophilic-lipophilic balance value of 1 to 8.

9. The method according to claim 8, wherein
the emulsifier includes at least one or at least two selected from the group consisting of a propylene glycol ester of a fatty acid, a polyglycerol ester of a fatty acid, a polyglycerol ester of interesterified ricinoleic acid, an organic acid monoglyceride, a sucrose fatty acid ester, and a sorbitan fatty acid ester.

10. The method according to claim 8, wherein
the applying the food coating agent includes applying the food coating agent to a heated food product, or the method further comprises heating the food product before or after the applying the food coating agent.

11. The food coating agent according to claim 2, wherein
at least 0.002 g/cm² of the food coating agent is to be applied to a partial area or an entire area of an exposed cheese surface of the food product for reduced hardening of a surface cheese portion of the food product.
